(19) United States
(12) Patent Application Publication
(10) Pub. No.: US 2019/0174667 A1
(43) Pub. Date: Jun. 13, 2019

(54) Method and Apparatus for Mapping Foreign Objects in a Field

(71) Applicant: Deere & Company, Moline, IL (US)

(72) Inventors: Valentin Gresch, Ensheim (DE); Robert Laga, Dresden (DE)

(21) Appl. No.: 16/216,457

(22) Filed: Dec. 11, 2018

(30) Foreign Application Priority Data
Dec. 11, 2017 (DE) 102017222403.7

(51) Int. Cl. A01B 79/00; G01V 9/00

(52) U.S. Cl. CPC A01B 79/005; A01C 7/08; G01V 9/00

(57) ABSTRACT

In one embodiment, a method for mapping foreign objects in a field is provided. The method comprising the steps of: traversing the field with an agricultural implement having an attachment, the attachment configured for at least one of penetrating into the soil of the field or running along on the soil; detecting, using a sensor associated with the attachment, a change of position of the attachment; determining, with a processor, whether the change of position of the attachment indicates interaction with a foreign object lying in the field; generating a position of the detected foreign object using a position determining system; and storing the generated position of the detected foreign object.

### RELATED APPLICATIONS

This document claims priority based on German Patent Application No. 102017222403.7, filed on Dec. 11, 2017, which is hereby incorporated by reference into this application.

### TECHNICAL FIELD

The present disclosure concerns a method and device for mapping foreign objects in a field during an agricultural operation.

### BACKGROUND

Soil erosion and deep working of the soil on agricultural fields can cause obstacles or foreign objects like stones to become transported to the upper soil layers. These objects lead to wear of the tools on soil working equipment and prevent uniform working of the field and planting. In very rocky fields, special machines (so-called stone pickers or stone breakers) are used for large scale removal of stones. However, the use of said machines is economically meaningful only in fields with extensive “pollution” with stones. For this reason, individual stones are manually collected in many cases. Also, obstacles like stones are often not detected from the cab of the machine, but can still cause considerable wear or damage to the tools or the (harvesting or soil working) machine. If stones are detected during the ongoing operation, the machine operator must give the removal over to other farm hands, since he often does not carry the necessary equipment for this.

The time-consuming wait for coworkers is also not very desirable. The machine operator must mark the point at which the stone lies and then communicate it to coworkers. The marking of countless occurrences is unreasonable for the driver. After the point of occurrence has been transmitted, the responsible person must locate the site of the obstacle by means of reference information, e.g., “there is a big rock about 50 meters to the left next to the utility pole in the back east end of the field”. This in turn is very time consuming, often does not lead to the desired result, and damages the soil due to repeated passes with heavy machines, for example if a tractor with a front loader is used to collect the stones. To treat the soil and seed material gently, such operations are avoided after planting. The location of the obstacle is often forgotten until after harvest and exposed objects can often become covered by overgrowth after planting. The danger that harvesting machines pick up such objects is quite high. Damage by undesirable objects can lead to machine failure with lengthy downtime.

A system for detecting undesirable objects (stones) in flat soil horizons could make it easier to detect said objects, to locate and remove them later, and to minimize the risk of damage to machines and equipment, and to enable uniform land management. It has been proposed that the locations of possible obstacles or stones can be entered by the operator into an electronic map during a field operation (European Patent Application No. 1 659 366 A2), allowing removal of the stones later, or to detect and to remove such objects automatically (European Patent Application No. 2 441 330 A2). Harvesting machines with means for optical detection of possible stones for purposes of raising the cutter head or going around the stone to avoid damage to a harvesting machine have likewise been proposed (German Patent Application No. DE 10 2015 118 767 A1, German Patent Application No. DE 10 2014 201 203 A1, German Patent Application No. DE 10 2007 053 577 A1, German Patent Application No. DE 10 2006 055 858 A1) and in addition to the mapping of stones visually detected by a camera of a hand apparatus for later removal from the field (European Patent Application No. 2 784 543 A2). In addition, it was proposed that the position of foreign objects possibly found by a harvesting machine be mapped allowing removal from the field later (European Patent Application No. 1 266 560 A1, European Patent Application No. 1 769 671 A1).

In the case of soil working and seeding machines, measures have been provided to mechanically protect elements that are engaged with the soil against damage by stones (see, for example, German Patent Application No. DE 43 39 443 A1), for which the elements engaged in the soil can move upward against a spring force to get out of the way. However, sensing of possible stones, let alone mapping them, is not provided.

Detection of foreign objects by the operator or a camera suffers from the fact that the foreign objects are barely detectable in poor light and moreover they often lie mostly or completely under the soil. Detection with a foreign object sensor of a harvesting machine helps only when the foreign object has already been picked up. Therefore, it would be desirable to make available an option of being able to also map foreign objects found in the soil and especially stones for purposes of later removal.

### SUMMARY

Various aspects of examples of the present disclosure are set forth in the claims. In one embodiment, a method for mapping foreign objects in a field is provided. The method comprising the steps of: traversing the field with an agricultural implement having an attachment, the attachment configured for at least one of penetrating into the soil of the field or running along on the soil; detecting, using a sensor associated with the attachment, a change of position of the attachment; determining, with a processor, whether the change of position of the attachment indicates interaction with a foreign object lying in the field; generating a position of the detected foreign object using a position determining system; and storing the generated position of the detected foreign object.

In another embodiment, an apparatus for mapping foreign objects in a field is provided. The apparatus comprising: an agricultural implement suitable for traversing the field; an attachment attached to the implement for at least one of penetrating into the soil of the field or running along on the soil; a sensor associated with the attachment, the sensor configured to detect changes in position of the attachment and generate an attachment signal; a position determining system configured to generate a position signal representative of the position of the attachment; and a processor configured to receive the attachment signal and determine whether the attachment has interacted with a foreign object lying in the field and, upon determining the attachment has interacted with a foreign object, associating the position signal from the position determining system with the attachment signal.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawing, wherein:

FIG. 1 shows a side view of a tractor with a seeding machine;

FIG. 2 shows an enlarged view of the seeding machine;

FIG. 3 shows a top view of the tractor with the seeding machine;

FIG. 4 shows a flowchart for the control procedure for FIGS. 1-3; and

FIG. 5 shows a view of a spring tooth plow with a sensor.

### DETAILED DESCRIPTION

The method and device of the present disclosure, in its strictest sense, serves to prevent machine damage caused by stones. Since the farmer knows where stones are he can drive directly to them and remove them. The possibility of conducting this action after a long period of time or to give it to farm hands, even outside personnel, is also provided herewith. The use of the appropriate autonomous or manually steered machines for stone removal is also conceivable.

A soil working or agricultural implement, such as a seeding machine, having one or more attachments which perform at least one of running along on the soil of the field (for example, as a depth gauge wheel) or penetrating the soil (for example, as spring tines or furrow openers), monitors with a sensor to see if the attachment has mechanically collided with a foreign object, in particular a stone. If this is the case, the position of the collision determined using the positional data of a position determining system is entered into an electronic map. After triggering by the characteristic sensor signal (also called a position signal), the coordinate is accordingly detected and can be stored and displayed directly in the operator terminal of the machine. The foreign object can be removed later by means of the map or even during the ongoing field operation. The stored coordinates of the obstacles can be sent for evaluation via a wireless network connection directly to an internet-based farm management portal or to any other computer for further evaluation and operational planning. Via said portal or computer it is likewise possible to send the data to other machines. Thus, an operator of a (harvesting) machine can be advised in a subsequent operation that he is approaching an object, so that he can accordingly react faster and more directly if he picks up the object, or he can manually or automatically steer around the object. Exemplary equipment on which the present disclosure can find use includes passive equipment operating on flat surfaces. This includes spring tooth cultivators, hoes, tine harrows, harrows, disk harrows, light cultivators, and seeding machines.

Additionally, a detection of stones based on imaging sensors (2-D camera, stereo camera) or other optical sensors can also be realized, or an entry capability can be provided for the operator, to be able to enter stones or other objects visually detected around the location. The sensor can identify, relative to the implement, the position of the soil engagement means, which is mounted so that it can move with respect to the implement. A change of position then points to an interaction with a stone or other object or obstacle.

The agricultural implement can comprise a wheel that runs on the soil of the field, while the sensor detects the vertical position of the wheel and a foreign object is detected by means of a vertical acceleration or velocity of the wheel that exceeds a certain threshold. The agricultural implement in a further refinement can comprise two laterally adjacent wheels running on the soil of the field, while a sensor detects the vertical position of each of the wheels and the lateral position of a foreign object is detected by the positions of the wheels. Still further, the agricultural implement can comprise an attachment such as a furrow opener or tine that penetrates the soil and is connected to the implement by a four-bar linkage or spring shaft. The sensor detects the position of a region of the of the four-bar linkage or shaft with respect to the implement.

In another embodiment the sensor can detect mechanical vibrations induced in the attachment by the collision of the attachment with a foreign object. Such a collision of tool produces a characteristic noise, which is detected by a microphone or vibration sensor and can be verified by an evaluation unit, as is substantially known from stone detectors in harvesting machines. It is also conceivable for the attachment to be supported by a stone protection device on the implement and for the sensor to register a response of the stone protection device.

A step of transmitting the signals of the sensor (also called an attachment signal) and/or the detected position of the detected foreign object to a remote site can also be provided. Accordingly, the evaluation of the signals of the sensor need not take place on board the implement or a towing vehicle, but rather can be undertaken at the remote site, which, for example, can be located on a farmstead or a computer center. Accordingly, the evaluation can take place through a computer located at any site to which the signals are sent via suitable wired (internet) or wireless (mobile net) means of transmission. The farmer can then access the data for his field from a stationary or mobile device. The detection of the position of the implement or a towing vehicle can take place at a mounting position of an antenna of the position determining system, where a conversion of the position of the antenna to the position of the attachment at the time of detection of the interaction of the tool with the foreign object is provided and stored.

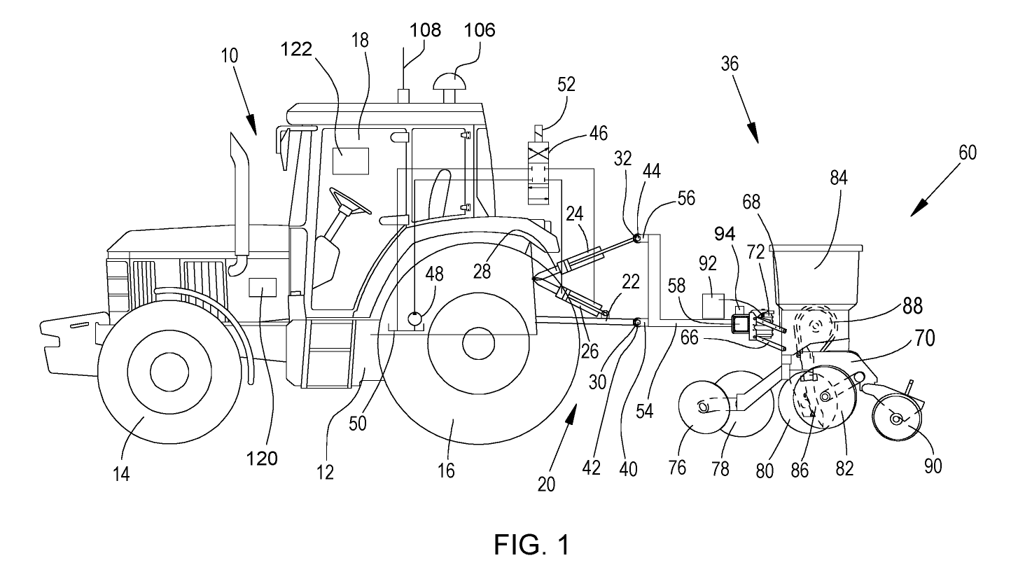

FIG. 1 shows a farm tractor 10, which is built on a chassis 12 and is supported on the soil by front steerable wheels 14 and driven rear wheels 16. An operator position is situated in a cab 18. At the rear end of the chassis 12 there is a three-point hitch 20, which is composed of two lower link arms 22, which are disposed side by side, and an upper link arm 28 mounted above them. The lower link arms 22 are height-adjustable by associated double acting hydraulic cylinders 26, which pivot the lower link arms 22 about horizontal axes, which are oriented approximately transverse to the forward direction, and about their linkage point on chassis 12. The upper link arm 28 is designed as a hydraulic cylinder 24 and accordingly can be changed in length. By adjusting the hydraulic cylinder 26, rear hitch points 30 of the lower link arms 22 can be brought into a position suitable for attaching the seeding machine 36. By adjusting the length of the upper link arm 28, which can also be done purely mechanically by hand by the operator by means of a suitable screw spindle instead of by the hydraulic cylinder 24, a rear hitch point 32 of the upper link arm 28 can be brought into a position suitable for attaching the seeding machine 36. At the rear end of the lower link arms 22, lower link hitch points 30 in the form of upward extending catch hooks (or any other hitch points, for example hitch eyes, as described in DIN ISO 730-1 Land machines and Tractors—Rear Three Point Attachment—Part 1: Categories 1, 2, 3, and 4) are arranged, while a likewise conventional hitch point 32 is provided at the rear end of the upper link arm 28.

The double acting hydraulic cylinder 26 of the lower link arm 22 is connected to a valve 46, which in turn is connected to a supply tank 50 for hydraulic fluid and a pump 48 driven by the combustion engine of the tractor 10. The valve 46 can be connected to both hydraulic cylinders 26 or a separate valve 46 can be associated with each hydraulic cylinder. The valve 46 can be brought into a closed position, as shown, and into a lowering position, when it is shifted upward in FIG. 1, and into a lifting position, when it is shifted downward in FIG. 1. Valve 46 can be actuated manually by the operator in the cab 18 or by suitable electromagnetic actuators 52, which in turn are actuated by switches disposed in the cab 18 or a headland automation system (not shown). In the position of valve 46 shown in FIG. 1, the lower link arm 22 is blocked and thus locked. The hydraulic cylinder 24 of the upper link arm 28 serves only for a one-time, initial setting of the position of the hitch point 32 and it is not adjusted during field operation, but rather is then blocked (as the hydraulic cylinder 26 of the lower link arm 22 shows by means of the valve 46 in FIG. 1). At the end of the field, the seeding machine 36 can be raised by the valve 46 being brought into the lift position by the operator or the headland automation system and can be lowered again analogously before working the next row, by the valve 46 being brought into the lowering position by the operator or the headland automation system. Through this, the lower link arms 22 are raised and again lowered by the hydraulic cylinders 26, so that the seeding machine 36 is also raised and lowered.

The seeding machine 36 comprises a mounting bar 54, which is affixed to the lower hitch points 30 of the lower link arm 22 by lower plates and bolts 42 and to the upper hitch point 32 by an upper mounting element 56 and a bolt 44. A transverse carrier 58, which extends over the entire width of the seeding machine 36 and to which several seeding units 60 are affixed side by side, is affixed to the support bar 54. The seeding units 60 are attached to the transverse carrier 58 via U-shaped brackets 62, which are connected to a console 64, which extends vertically at the rear of the transverse carrier 58 and to which two link arms 66, 68 are hinged one above the other, which additionally are each hinged to a frame 70 of the seeding unit 60. The link arms 66, 68 together with console 64 and frame 70 form an adjustable parallelogram or four-bar linkage, which defines the height of the frame 70 above the soil. A pneumatic actuator 72 serving as tensioning means, which in this embodiment is designed as a pneumatic bellows, engages on the one hand the console 64 above and on the other hand the lower link arm 66 (at point 74) below and defines the position of the frame 70 and the force with which furrow openers 78, 80, which are supported on frame 70, interact with the soil. The pressure in pneumatic actuator 72 is set by a pneumatic control unit 92, which can comprise a compressor and a pressure control valve. A hydraulic cylinder (not shown) or electric actuator (not shown) could also be used instead of the pneumatic actuator 72.

The frame 70 carries, in a substantially known way, a seed container 84, a seed tube 86, and a metering device 88 (in particular a pneumatic device, operating with a negative pressure provided by a blower, which is not shown), which releases individual seeds one by one from the seed container 84 to the seed tube 86, which places it in a furrow, which is produced by the furrow opener 80, the operating depth of which is set by a depth gauge wheel 82. The furrow is closed by a closing wheel 90. An additional furrow can be produced by a furrow opener 78, the operating depth of which is set by a depth gauge wheel 76. Said additional furrow can serve to accept fertilizers via an additional plow, not shown, and likewise can be closed by the closing wheel 90. Regarding additional details of the seeding machine units 60, one is referred to the disclosure of European Patent Application No. 2 517 545 A1, the disclosure of which is incorporated into these documents by reference.

The downward pressure of the furrow opener 80 is set by the pneumatic actuator 72 and could be variable for adjusting to the relevant conditions on the field by means of the pneumatic control unit 92 which can be controlled by the operator from the cab 18 via an interface (for example virtual terminal 122) and a bus (not shown). The pneumatic actuator 72 could also be replaced or supplemented by a spring (not shown), which is connected in parallel with it.

It should be noted that still further modifications of the seeding machine 36 would be conceivable. Thus, the transverse carrier 58 could be composed of a plurality of segments, which allows outer segments with the attached seeding units 70 to be brought into an outer operating position that is offset upwardly and inwardly for road travel. A fertilizer holder, the contents of which are deposited successively in the above-mentioned additional furrow by suitable, substantially pneumatic conveyor means, could be mounted at the front of the tractor 10. Also, the transverse carrier 58 could be supported on its own chassis, which is pulled on wheels behind the tractor 10 on a draw bar (not shown). In this case the weight of the seeding machine 36 (needed to generate the downward pressure) is provided by its chassis and the elements affixed thereto, such as a seed tank.

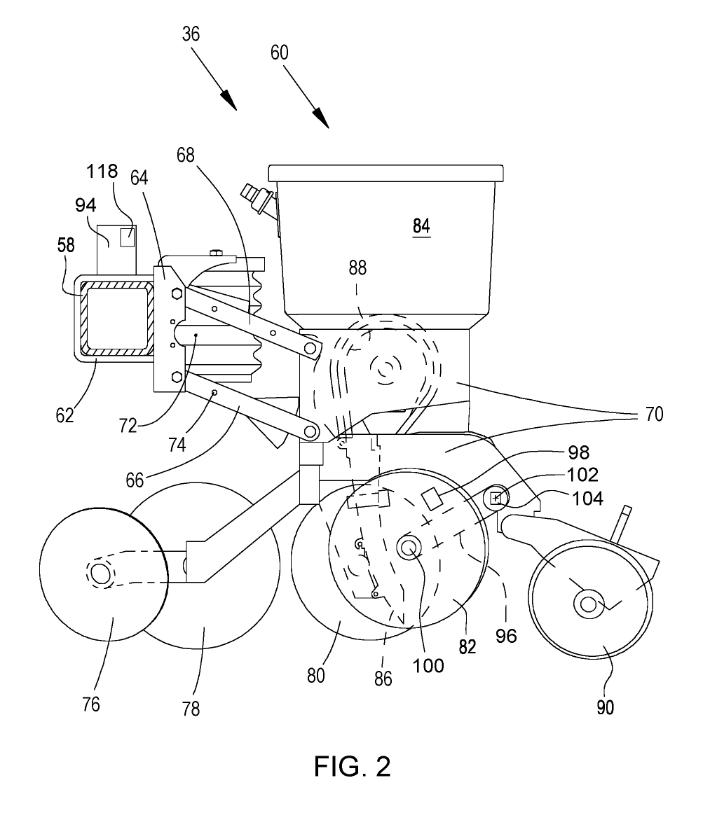

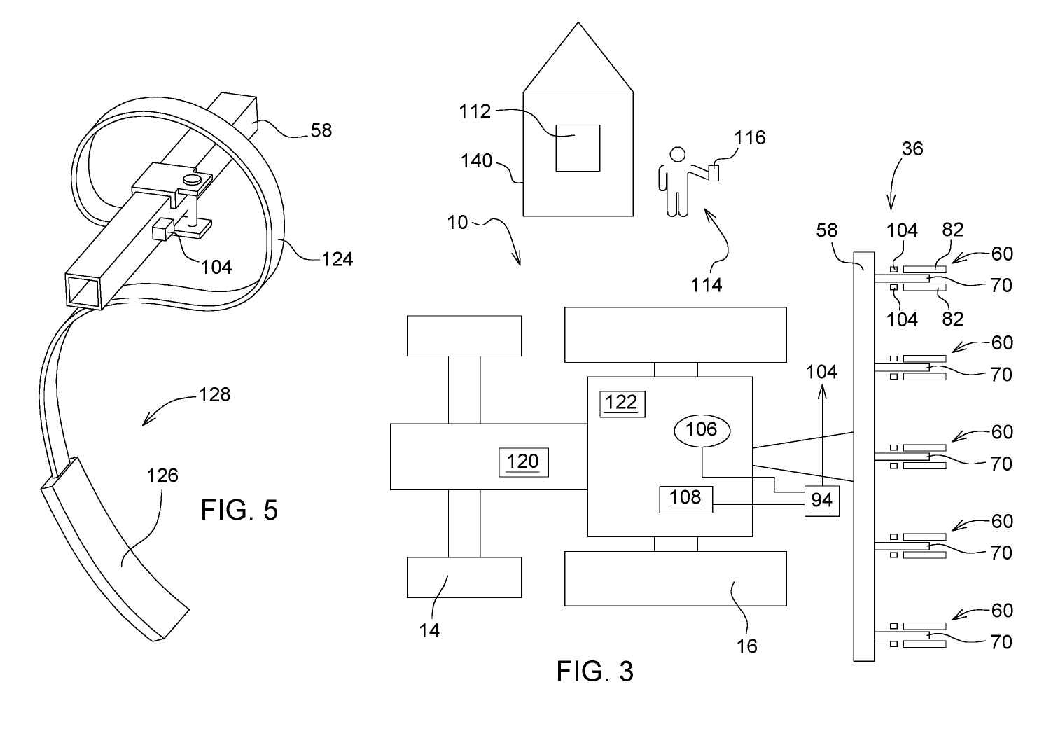

As shown in FIG. 2, the depth gauge wheel 82 is mounted on a swing arm 96 freely rotatable about an axis of rotation 100 that is horizontal and extends transversely. The swing arm 96 is in turn mounted on frame 70 freely rotatable about a horizontal and transverse axis of rotation 102. The upward swing of the swing arm 96 is defined by a stop 98, which can be fixed or adjustable in height by hand or by means of an actuator (not shown, but see U.S. patent application Ser. No. 15/783,264, the disclosure of which is incorporated into these documents by reference). It can be seen from FIG. 3 that each row unit 70 comprises two depth gauge wheels 82 which are disposed one on each side of the frame 70. The angle of rotation of the swing arm 96 about the axis of rotation 102 is detected by means of a sensor 104, which can be a potentiometer, or an inductive distance sensor is used, which measures the distance to a target surface, as disclosed in U.S. patent application Ser. No. 15/783,264. Said target surface is designed so that the distance between the target surface coupled to the swing arm 96 and the sensor varies linearly or nearly linearly with the angle of the swing arm 96 relative to frame 70.

The sensor 104 is connected to a control unit 94, which in turn is connected via a bus system, which is also connected to a control unit 120 of the tractor 10 and a virtual terminal 122 disposed in its cab 18, to a position determining device 106 disposed on board the tractor 10 and a sending device 108 likewise disposed on board the tractor 10, which can transmit data to a computer 112 at a remote site 110 and/or to a portable device 116 of a user 114. The control unit 94 can also control the control unit 92 of the actuators 72, although it would be conceivable [as] in the function described below to arrange a separate control unit 94, which does not serve to control the actuators of the seeding machine 36. Also, the control unit 120 of the tractor 18 or software running on the virtual terminal 122, or a portable device (smart phone, etc.) connected to the bus system could take on the job of the control unit 94.

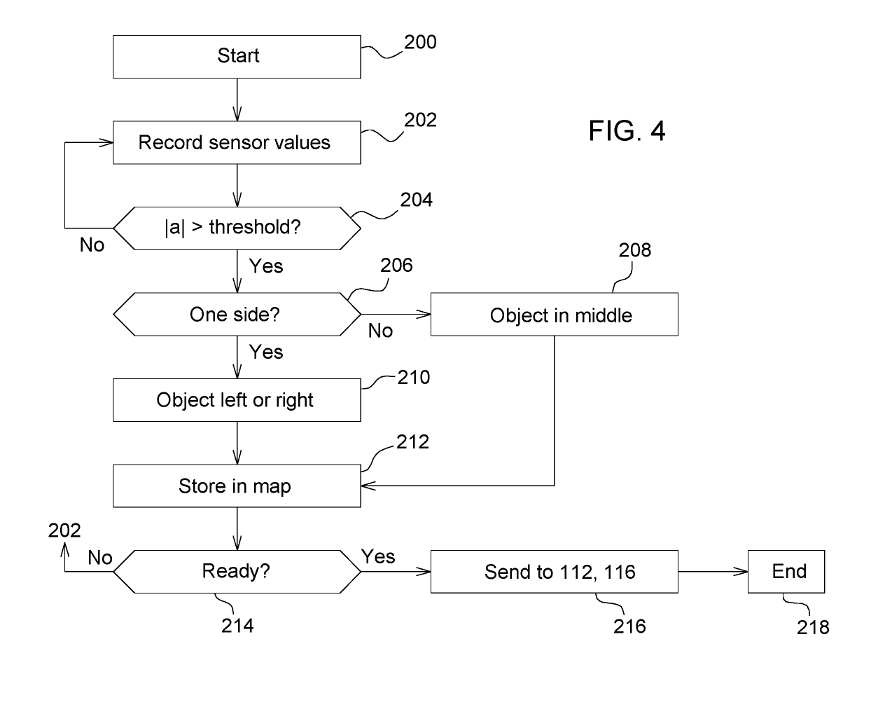

FIG. 4 shows a flow chart according to which the control unit 94 operates. The start in step 200 is followed by step 202, in which the signals of the sensor 104 of the seeding machine 36 are sent to the control unit 94.

In step 204 a test is made to see if the value of the acceleration or velocity of a depth gauge wheel 82 (i.e., the second or first derivative with respect to time of the signal of the sensor 104) lies above a threshold value. Since the relevant depth gauge wheel 82 deviates downward when it passes over a depression, but the frame 70 remains at the same height, it can be assumed from this that if there is a slow sinking or rising of the depth gauge wheel 82, a normal soil depression is present, while a stone is being run over if there is a faster sinking or rising of the depth gauge wheel 82.

If step 204 indicates that the value of the acceleration of a depth gauge wheel 82 does not lie above the threshold value, step 202 again follows. Otherwise, step 206 follows, in which a test is made to see if the threshold value was likewise exceeded on the other side of the frame 70 of the seeding unit 60. If this is not the case, step 210 follows, in which it is established that a stone is present only on the side of the frame 70 at which the threshold value was exceeded, while otherwise step 208 follows, in which it is established that a stone is present on both sides of the frame 70.

The algorithm described here accordingly emerges from a total of five possibilities of how the depth gauge wheels 82 and thus the values of the sensors 104 can behave:
1) The measured curves do not have deflections. This means that the system is operating smoothly and no events are being detected.
2) Both measurement values move oppositely away from or toward one another over a long period of time (i.e., with acceleration or velocity lying under the threshold value). In this case a depression or a rise is being detected on one side of the seeding unit 60. Detection of a stone is not needed here. It should still be noted that a deflection of the sensor value downward corresponds to a rise of the corresponding depth gauge wheel 82.
3) The sensor values move oppositely away from each other. This indicates that the left gauge wheel 82 is rising and the right gauge wheel 82, through the function of the suspension of the seeding unit 60 on the transverse carrier 58 by the actuator 72, is moving downward. The undesirable object is thus at the left depth gauge wheel 82. The position coordinate of the left depth gauge wheel 82 is detected and stored at this time point.
4) The sensor valves move oppositely toward each other. This indicates that the right depth gauge wheel 82 is rising and the left depth gauge wheel 82, through the function of the suspension of the seeding unit 60 on the transverse carrier 58 by the actuator 72, is moving downward. The undesirable object is thus at the right depth gauge wheel 82. The position coordinate of the right depth gauge wheel 82 is detected at this time point and stored.
5) The sensor values move in the same direction. This indicates that the entire seeding unit 60 is rising. The object is thus at the furrow opener 80. The position coordinate of the furrow opener 80 (longitude, latitude and, as required, elevation) is detected at this time point and stored.

Both steps 210 and 208 are followed by step 212, in which the position of the object (stone) is stored in a map in a memory 118 of the control unit 94. For this the data of the position determining system 106 are used, signals from satellites of a GNSS (for example, GPS, Galileo and/or Glonass) are received, and from this the position of its antenna is derived and is converted by the control unit 94 to the position of the stone (in two- or three-dimensional coordinates) in accordance with step 210 or 208 by means of mechanical measurements known to the control unit 94 (horizontal and vertical offsets between the position determining system 106 and the relevant depth gauge wheels 82) and by means of the direction of travel and optionally the orientation of the seeding machine 36 with respect to the tractor 10 (which is variable in the case of a draw bar hitch), in which regard one is referred to the disclosure of European Patent Application No. 0 970 595 A1.

Step 212 is followed by step 214, which queries if the field has been completely worked. If this is not the case, step 202 repeats and otherwise step 216, in which the map of stones in the field stored in memory 118 is transmitted to the computer 112 and/or the portable device 116. Then the procedure is ended in step 218. The manager 114 can thus arrange for the removal of the stones from the field.

In the embodiment in FIG. 5, a spring tooth plow 128 is equipped with a sensor 104. The sensor 104, which is mounted on a transverse carrier 58, measures the distance to the shaft 124 of the spring tooth plow 128, since the radius of the shaft 124 will change in each case according to the force acting on the plow tip 126. A sudden change of signal of sensor 104 indicates an object (stone). At this time the position coordinate of the plow tip 126, which is in engagement with the soil, is detected by a control unit 94 (in the manner described above) and mapped in accordance with the previous embodiment.

The spring tooth plow 128 shown in FIG. 5 can be mounted between laterally adjacent seeding units 60 of the embodiment in accordance with FIGS. 1 to 4, to monitor the field for stones as completely as possible in the transverse direction (in combination with depth gauge wheels 82 that are as wide as possible).

If on the other hand, in the case of seeding machine 36, significant lateral gaps remain on the field between regions monitored for stones, the said machine or another machine working the soil can cover the said regions in a subsequent operation. Thus, when cultivating the field, the region not yet worked by the seeding machine 36 of FIGS. 1 to 4 between its seeding units 60 can be worked with a machine equipped with the spring tooth plows of FIG. 5.

Also, conceivable for stone detection are systems having acceleration sensors, transducers, and strain gauges and that operate with any kind of attachment. These measurement signals would operate with an object detection algorithm like what is shown in FIG. 4, to detect stones. In the case of equipment with spring damper elements (subsoilers, heavy cultivators), flows can also be used to detect objects. Some agricultural implements, such as seeding machines, have so-called stone protection devices. Sensing the actuation of these stone protection devices can provide a conclusion about the presence and position of the undesirable object.

A use of stereo cameras and 2-D cameras is also conceivable for stone detection. These can be implemented so that exposed stones can already be detected before traveling over them and can be moved out of the way.

Besides the described automatic detection of stones, it is also possible for there to be two manual functions to generate the mapping of objects. The first manual function provides that after a perceptible shaking of the tractor/trailer combination, after removal of a foreign object from the operating implement, or after a visual analysis (the actuation of a stone protection device on the plow), an icon in the machine display (on virtual terminal 122) can be operated, which allows a storage of the current machine position. The method then serves to limit the search area for stones.

The second manual function provides, after visual contact with an obstacle, for a marking for the object to be made on a digital map after estimation of the position on the map, by means of display contact (on the virtual terminal 122). It is also possible to combine the functions so that automatic markings can be created and manually made.

Thus, the system can find use on all implements, regardless of whether the operating implement is equipped with a sensor system or not. At the same time, foreign objects other than stones, such as accumulations of harvest residues or objects left on the field can also be marked.

Different symbols can be used for automatic and manually set markings. Manually set markings can additionally be given a function for adding comments. For example, automatically marked obstacles can be represented by flag symbols, while the manually set markings can be represented by semicircular symbols.

The stored coordinate points can then be processed on the machine gathering the data or at a remote site. Thus, they can be displayed on a map and/or processed, to accumulate the mapped points by means of a device, to find and remove the object. The points can be stored and transmitted to other machines by means of an internet-based portal. There the stored data points can be displayed on the machine display (i.e., on a virtual terminal 122 of the other machine). The machine operator will get an early indication of hazard sites in this way and can react faster. The present disclosure thus enables a warning against foreign objects like stones even in stands that are so densely grown that, for example, the driver of a harvester can no longer see the soil.

By using the manual or automatic marking in a map, foreign objects that were picked up by harvesters can likewise be precisely stored in the system after the machines have moved on. In corn harvesting, it is exactly near roads, alleyways, and pastures that wooden beams, branches, and marking pillars, and stones that were not detected by a metal detector, are picked up and trigger the overload protection of the machine. They must then be removed manually. The driver can, for example, store the object on the “right cutter width” and configure said point in the machine display and actuate the marking trigger. The object can be removed before the next operating step.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

As will be appreciated by one skilled in the art, certain aspects of the disclosed subject matter can be embodied as a method, system (e.g., a work vehicle control system included in a work vehicle), or computer program product. Accordingly, certain embodiments can be implemented entirely as hardware, entirely as software (including firmware, resident software, micro-code, etc.) or as a combination of software and hardware (and other) aspects. Furthermore, certain embodiments can take the form of a computer program product on a computer-usable storage medium having computer-usable program code embodied in the medium.

Any suitable computer usable or computer readable medium can be utilized. The computer usable medium can be a computer readable signal medium or a computer readable storage medium. A computer-usable, or computer-readable, storage medium (including a storage device associated with a computing device or client electronic device) can be, for example, but is not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium can be any tangible medium that can contain, or store a program for use by or in connection with the instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electromagnetic, optical, or any suitable combination thereof. A computer readable signal medium can be non-transitory and can be any computer readable medium that is not a computer readable storage medium and that can communicate, propagate, or transport a program for use by or in connection with an instruction execution system, apparatus, or device.

Aspects of certain embodiments are described herein can be described with reference to flowchart illustrations and/or block diagrams of methods, apparatus (systems) and computer program products according to embodiments of the invention. It will be understood that each block of any such flowchart illustrations and/or block diagrams, and combinations of blocks in such flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions can also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any flowchart and block diagrams in the figures, or similar discussion above, can illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block (or otherwise described herein) can occur out of the order noted in the figures. For example, two blocks shown in succession (or two operations described in succession) can, in fact, be executed substantially concurrently, or the blocks (or operations) can sometimes be executed in the reverse order, depending upon the functionality involved. It will also be noted that each block of any block diagram and/or flowchart illustration, and combinations of blocks in any block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s). Accordingly, various embodiments and implementations other than those explicitly described are within the scope of the following claims.

1. A method for mapping foreign objects in a field, the method comprising the steps of:
traversing the field with an agricultural implement having an attachment, the attachment configured for at least one of penetrating into the soil of the field or running along on the soil;
detecting, using a sensor associated with the attachment, a change of position of the attachment;
determining, with a processor, whether the change of position of the attachment indicates interaction with a foreign object lying in the field;
generating a position of the detected foreign object using a position determining system; and
storing the generated position of the detected foreign object.

2. The method of claim 1 wherein the attachment is movably mounted with respect to the agricultural implement and the sensor detects changes in position of the attachment relative to the agricultural implement.

3. The method of claim 2 further comprising:
running a wheel attached to the agricultural implement along the soil of the field;
detecting, using a sensor associated with the wheel, the vertical position of the wheel; and
determining, with the processor, the presence of a foreign object based on the amount by which a vertical acceleration or velocity of the wheel exceeds a specific threshold value.

4. The method of claim 2 further comprising:
running a pair of wheels attached to the agricultural implement along the soil;
detecting, using a sensor associated with the pair of wheels, the changes in vertical position of each wheel; and
determining, with the processor, the lateral position of a foreign object based on the amount of change in positions of the pair of wheels.

5. The method of claim 2 further comprising:
penetrating the soil with a soil working tool connected to the agricultural implement by a shaft;
detecting, with a sensor associated with the soil working tool, changes in position of a region of the shaft with respect to the agricultural implement; and
determining, with the processor, the presence of a foreign object based on the amount of change in the position of the shaft.

6. The method of claim 1 further comprising the step of detecting, using the sensor associated with the attachment, mechanical oscillations induced in the attachment by the collision of the attachment against a foreign object.

7. The method of claim 2 wherein the attachment is protected by a foreign obstacle protection device on the agricultural implement and the sensor detects a response of the foreign obstacle protection device.

8. The method of claim 1 further comprising the step of transmitting to a remote site at least one of the signals of the sensor or the detected position of the detected foreign object.

9. The method of claim 1 further comprising the step of determining at least one of the position of the agricultural implement or a vehicle towing the agricultural implement, using the mounting position of an antenna of the position determining system and the position of the attachment relative to the antenna at the time of the detection of the interaction of the attachment with the foreign object.

10. An apparatus for mapping foreign objects in a field comprising:
an agricultural implement suitable for traversing the field;
an attachment attached to the implement for at least one of penetrating into the soil of the field or running along on the soil;
a sensor associated with the attachment, the sensor configured to detect changes in position of the attachment and generate an attachment signal;
a position determining system configured to generate a position signal representative of the position of the attachment;
a processor configured to receive the attachment signal and determine whether the attachment has interacted with a foreign object lying in the field and, if the attachment has interacted with a foreign object, associating the position signal from the position determining system with the attachment signal.

11. The apparatus of claim 10 wherein the position determining system generates the position signal using the mounting position of an antenna of the position determining system and the position of the attachment relative to the antenna at the time of the detection of the interaction of the attachment with the foreign object.

12. The apparatus of claim 10 wherein the attachment is movably mounted with respect to the agricultural implement and the sensor detects changes in position of the attachment relative to the agricultural implement.

13. The apparatus of claim 12 wherein the attachment is a wheel attached to the agricultural implement, the wheel running along the soil of the field.

14. The apparatus of claim 13 wherein the sensor detects changes in the vertical position of the wheel.

15. The apparatus of claim 14 wherein the processor is configured to determine the presence of a foreign object based on the amount by which a vertical acceleration or velocity of the wheel exceeds a specific threshold value.

16. The apparatus of claim 12 wherein the attachment is a pair of wheels attached to the agricultural implement running along the soil.

17. The apparatus of claim 16 wherein the sensor associated with the pair of wheels detects the change in position of each wheel.

18. The apparatus of claim 17 wherein the processor determines the lateral position of a foreign object based on the amount of change in positions of the pair of wheels.

19. The apparatus of claim 12 wherein the attachment is a soil working tool connected to the agricultural implement by a shaft.

20. The apparatus of claim 19 wherein the sensor associated with the soil working tool detects changes in position of a region of the shaft with respect to the agricultural implement.
